(19) United States
(12) Patent Application Publication
(10) Pub. No.: US 2025/0155877 A1
(43) Pub. Date: May 15, 2025

(54) Early Alert Method and Apparatus, Process Instrument Comprising Early Alert Apparatus, and Computing Device

(71) Applicant: Siemens Aktiengesellschaft, München (DE)

(72) Inventors: Yan Bin Peng, Beijing (CN); Qing Gang Wang, Beijing (CN); Yan Wang, Beijing (CN); Tong Zhou Wang, Beijing (CN); Meng Zhang, Beijing (CN)

(73) Assignee: Siemens Aktiengesellschaft, München (DE)

(21) Appl. No.: 18/838,915

(22) PCT Filed: Feb. 17, 2022
(86) PCT No.: PCT/CN2022/076690

§ 371 Date: Aug. 15, 2024

(51) Int. Cl. G05B 19/418

(52) U.S. Cl. CPC G05B 19/4184; G05B 2219/31439

(57) ABSTRACT

An example includes: receiving a process variable; predicting a estimation value by linear fitting on a number of recent values, comparing that with a warning threshold, and if greater, setting the estimation value as a first value; comparing the current value with a value at the same position in the previous cycle to determine a deviation value, adding the deviation value to the previous peak value or trough value to serve as a maximum estimation value, comparing the maximum value with the preset warning threshold, and if greater, setting the maximum value as a second estimation value; computing a estimation value on the basis of the first and the second estimation; comparing the process variable estimation value with the preset warning threshold; and issuing an early alert signal if the estimation value is greater than the threshold.

### CROSS-REFERENCE TO RELATED APPLICATIONS

This application is a U. S. National Stage Application of International Application No. PCT/CN2022/076690 filed Feb. 17, 2022, which designates the United States of America, the contents of which are hereby incorporated by reference in their entirety.

### TECHNICAL FIELD

The present disclosure relates generally to the Internet of Things (IoT). Various embodiments of the teachings herein include early alert methods and/or apparatus.

### BACKGROUND

Process instruments are generally instruments used on a mass production operating line for measuring, monitoring and inspecting physical variables in an industrial process such as temperature, pressure, flow rate, liquid level and valve positioning. Examples of process instruments include temperature sensors, pressure sensors, liquid level meters and flow meters. If the value of a production physical variable measured by a process instrument exceeds a preset limit, warning and alarm signals will be sent to a management system or control system.

A typical example of a process instrument is a temperature transmitter. A temperature transmitter has a pair of warning thresholds (an upper limit and a lower limit) and a pair of alarm thresholds. If a measurement value exceeds a warning threshold but is within the alarm thresholds, a warning signal is sent to a controller; if a measurement value exceeds an alarm signal, an alarm signal is sent to the controller. That is to say, a warning signal will only be sent if a measurement value of the process instrument has already exceeded a warning threshold.

### SUMMARY

A brief summary is given here to provide a basic understanding of certain aspects of the present disclosure. This summary is not an exhaustive summary thereof. It does not specify key or important parts of the teachings, nor does it define the scope of the present disclosure. Its sole purpose is to set out certain concepts in simplified form, as a preamble to the more detailed description which follows.

For example, some embodiments of the teachings herein include a method for predicting process variable measurement values that might occur in future, wherein predicted process variable estimation values are compared with a preset warning threshold, and an early alert may be sent to a management system or a control system in advance if an estimation value is greater than the preset warning threshold.

In some embodiments, an early alert method for a process instrument comprises: receiving a measurement value of a process variable measured by a process instrument; predicting a linear estimation value using a linear prediction model, which is generated by performing linear fitting on a predetermined number of measurement values recently measured by the process instrument, comparing the linear estimation value with a preset warning threshold, and if the linear estimation value is greater than the preset warning threshold, setting the linear estimation value as a first estimation value; analysing a position of a current measurement value in a measurement value cycle of the process variable, comparing the current measurement value with a value of the process variable at the same position in the previous cycle to determine a deviation value, then adding the deviation value to the previous peak value or trough value to serve as a maximum estimation value, comparing the maximum estimation value with the preset warning threshold, and if the maximum estimation value is greater than the preset warning threshold, setting the maximum estimation value as a second estimation value; computing a process variable estimation value on the basis of the first estimation value and the second estimation value; and comparing the process variable estimation value with the preset warning threshold and issuing an early alert signal if the process variable estimation value is greater than the preset warning threshold.

In some embodiments, computing comprises computing the process variable estimation value in a weighted manner on the basis of the first estimation value and the second estimation value and respective weights thereof.

In some embodiments, the measurement value cycle is obtained by analysing received measurement values of multiple process variables to determine the periodicity of the process variables.

In some embodiments, the method further comprises receiving a time period and a maximum threshold set by a user, wherein the overall prediction step further comprises estimating an accumulated value of the process variable within the time period on the basis of the first estimation value and/or the second estimation value, and issuing an early alert signal if the accumulated value is greater than the maximum threshold.

As another example, some embodiments include an early alert apparatus comprising: a measurement value receiving unit, configured to receive a measurement value of a process variable measured by a process instrument; a first estimation value determining unit, configured to predict a linear estimation value using a linear prediction model, which is generated by performing linear fitting on a predetermined number of measurement values recently measured by the process instrument, compare the linear estimation value with a preset warning threshold, and if the linear estimation value is greater than the preset warning threshold, set the linear estimation value as a first estimation value; a second estimation value determining unit, configured to analyse a position of a current measurement value in a measurement value cycle of the process variable, compare the current measurement value with a value of the process variable at the same position in the previous cycle to determine a deviation value, then add the deviation value to the previous peak value or trough value to serve as a maximum estimation value, compare the maximum estimation value with the preset warning threshold, and if the maximum estimation value is greater than the preset warning threshold, set the maximum estimation value as a second estimation value; an estimation value computing unit, configured to compute a process variable estimation value on the basis of the first estimation value and the second estimation value; and an overall prediction unit, configured to compare the process variable estimation value with the preset warning threshold, and issue an early alert signal if the process variable estimation value is greater than the preset warning threshold.

As another example, some embodiments include a process instrument comprising an early alert apparatus as described herein, the early alert apparatus issuing an early alert signal if an estimation value of a process variable measured by the process instrument is greater than a preset warning threshold.

As another example, some embodiments include a computing device comprising: at least one processor; and a memory coupled to the at least one processor, the memory being used to store an instruction which, when executed by the at least one processor, causes the processor to execute one or more of the methods described herein.

As another example, some embodiments include a non-transitory machine-readable storage medium storing an executable instruction which, when executed, causes the machine to execute one or more of the methods described herein.

As another example, some embodiments include a computer program product stored on a tangible computer-readable medium and comprising a computer-executable instruction which, when executed, causes at least one processor to execute one or more of the methods described herein.

The present disclosure describes intelligent early warning mechanisms preceding a standard warning/alarm mechanism, for performing linear prediction on the basis of historical data, and also adding a deviation value to a peak (trough) value on the basis of data periodicity to perform prediction, these two types of prediction being combined to determine a possible future estimation value of a process variable, giving an early warning for a process variable that might exceed a warning threshold, thus enabling earlier fault prediction and diagnosis, and avoiding greater harm during production.

### BRIEF DESCRIPTION OF THE DRAWINGS

The above and other objectives, characteristics and advantages of teachings of the present disclosure will be understood more easily with reference to the following description of example embodiments in conjunction with the drawings. The components in the drawings are merely intended to show the principles of the present disclosure. In the drawings, identical or similar technical features or components are indicated by identical or similar reference numerals. In the drawings:

FIG. 1 is a flow chart of an exemplary process of an early alert method incorporating teachings of the present disclosure;

FIG. 2 is a block diagram of an exemplary configuration of an early alert apparatus incorporating teachings of the present disclosure;

FIG. 3 shows a schematic drawing of a process instrument incorporating teachings of the present disclosure; and

FIG. 4 shows a block diagram of a computing device 400 for executing an early alert method incorporating teachings of the present disclosure.

### KEY TO THE DRAWINGS

100: early alert method
S102, S104, S106, S108, S109, S110: steps
200: early alert apparatus
202: measurement value receiving unit
204: first estimation value determining unit
206: second estimation value determining unit
208: estimation value computing unit
210: overall prediction unit
209: user setting unit
300: process instrument
400: computing device
402: processor
404: memory

### DETAILED DESCRIPTION

The subject matter described herein will now be discussed with reference to exemplary embodiments. These embodiments are discussed for the sole purpose of enabling those skilled in the art to better understand and thereby implement the subject matter described herein, without limiting the protection scope, applicability or examples expounded in the claims. Changes may be made to the functions and arrangement of the discussed elements without departing from the scope of protection of the content of the present disclosure. Various processes or components may be omitted, replaced or added in the examples as needed. For example, the described method may be performed in a different order from that described, and various steps may be added, omitted or combined. Furthermore, features described in relation to some examples may also be combined in other examples.

As used herein, the term “comprising” and variants thereof denote open terms, meaning “including but not limited to”. The term “based on” means “at least partly based on”. The terms “one embodiment” and “an embodiment” mean “at least one embodiment”. The term “another embodiment” means “at least one other embodiment”. The terms “first”, “second”, etc. may denote different or identical objects. Other definitions, explicit or implicit, may be included below. Unless clearly specified in the context, the definition of a term is the same throughout this Description.

Some embodiments of the teachings herein include a method for predicting process variable measurement values that might occur in future, wherein predicted process variable estimation values are compared with a preset warning threshold, and an early alert may be sent to a management system or a control system in advance if an estimation value is greater than the preset warning threshold.

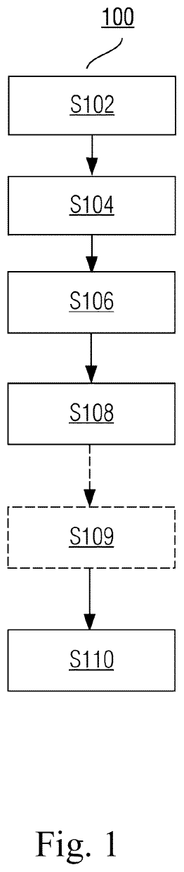

An example early alert method for a process instrument incorporating teachings of the present disclosure is described in detail below with reference to the drawings. FIG. 1 is a flow chart of an exemplary process of an early alert method 100 incorporating teachings of the present disclosure.

Firstly, in a measurement value receiving step S102, a measurement value of a process variable measured by a process instrument is received. Specifically, for example, a number of measurement values of a process variable measured by a sensor of a process instrument are received from this sensor.

Next, in a first estimation value determining step S104, a linear estimation value is predicted using a linear prediction model. The linear prediction model may be generated by performing linear fitting on a predetermined number of measurement values recently measured by the process instrument. For example, linear fitting may be performed on 10 or 50 recently measured data; the specific number of measurement values may be set as needed, and there is no restriction to a specific number. A linear prediction model for measurement values of a process instrument may be obtained by linear fitting; and a process variable value that might occur in future, referred to as a linear estimation value here, may be predicted on the basis of historical measurement data using such a linear prediction model.

The predicted linear estimation value is then compared with a preset warning threshold, and if the linear estimation value is greater than the preset warning threshold, the linear estimation value is set as a first estimation value.

There will be one preset warning threshold for each different process variable, and if a linear estimation value predicted using a linear prediction model is higher than the preset warning threshold, this linear estimation value is set as a first estimation value, which will serve as one of the factors which are considered together below to determine whether to trigger a warning.

Next, in a second estimation value determining step S106: a position of a current measurement value in a measurement value cycle of the process variable is analysed, the current measurement value is compared with a value of the process variable at the same position in the previous cycle to determine a deviation value, then the deviation value is added to the previous peak value or trough value to serve as a maximum estimation value, the maximum estimation value is compared with the preset warning threshold, and if the maximum estimation value is greater than the preset warning threshold, the maximum estimation value is set as a second estimation value.

The measurement value cycle mentioned here may be obtained in advance by analysing received measurement values of multiple process variables to determine the periodicity of the process variables. Measurement value cycles may for example be different units of time such as a second, a minute, an hour, a day and a night, a day, a week, a month, a quarter, a year, etc.

In this step, the difference between values of the process variable at the same position in two consecutive cycles is taken to be a deviation value, then this deviation value is added to the previous peak value or trough value, and the next maximum value (or maximum value of absolute value) of the process variable can thus be predicted. If the maximum estimation value is greater than the preset warning threshold, this maximum estimation value is set as a second estimation value, which will serve as the other of the factors which are considered together below to determine whether to trigger a warning.

Next, in an estimation value computing step S108, a process variable estimation value is computed on the basis of the first estimation value and the second estimation value. In this step, one process variable estimation value will be computed by combining the first estimation value and the second estimation value respectively determined in the first estimation value determining step and the second estimation value determining step.

Specifically, for example, different weights may be set for the first estimation value and the second estimation value respectively, then the first estimation value and the second estimation value may be subjected to weighted averaging to compute the process variable estimation value. Those skilled in the art may set different weights or confidences for the first estimation value and the second estimation value according to characteristics of different process variables or may use other algorithms to compute the process variable estimation value; the present invention does not define the specific algorithm for the process variable estimation value.

Finally, in an overall prediction step S110: the process variable estimation value is compared with the preset warning threshold, and an early alert signal is issued if the process variable estimation value is greater than the preset warning threshold.

In this way, the method shown includes an intelligent early warning mechanism preceding a standard warning/alarm mechanism, for performing linear prediction on the basis of historical data, and also adding a deviation value to a peak (trough) value on the basis of data periodicity to perform prediction, these two types of prediction being combined to determine a possible future estimation value of a process variable, giving an early warning for a process variable that might exceed a warning threshold, thus enabling earlier fault prediction and diagnosis, and avoiding greater harm during production.

In some embodiments, before the overall prediction step S110, the process instrument early alert method 100 further comprises a user setting step S109: receiving a time period and a maximum threshold set by a user. This step is for process variables whose values can be accumulated; for example, the user might want to know the status of flow consumption within a particular time period, so can set a maximum threshold and a time period of interest to the user, then use the method of the present invention to estimate an accumulated value of the process variable within this time period on the basis of the first estimation value and/or the second estimation value, then compare the estimated accumulated value with the maximum threshold set by the user, and if it is greater than this maximum threshold, an early alert signal may be issued.

In some embodiments, the process instrument is for example a household electricity meter, and the user may set a maximum amount of electricity consumption within one month. Using the first estimation value and/or the second estimation value determined according to the method of the present invention, an estimated amount of electricity consumption of the electricity meter for this month (an accumulated value of the process variable) may be predictively computed, and if this estimated amount of electricity consumption is greater than the maximum amount of electricity consumption set by the user, an early alarm signal may be sent to the user, indicating to the user that the predicted amount of electricity consumption for this month might exceed the preset maximum amount of electricity consumption.

Those skilled in the art may choose a suitable method according to characteristics of a process variable, for computing an accumulated value of the process variable within a particular time period on the basis of both the first estimation value and the second estimation value, or one of these; this is not detailed further here.

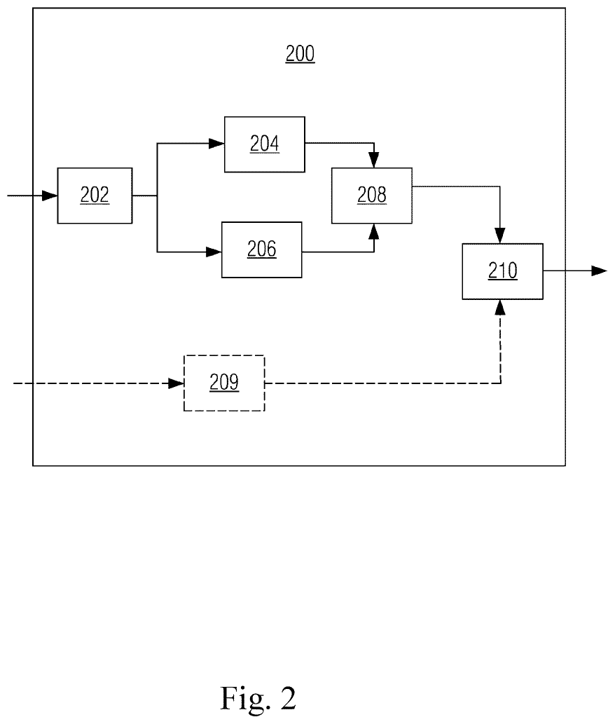

Some embodiments of the present disclosure further include an early alert apparatus for a process instrument; FIG. 2 is a block diagram of an exemplary configuration of an early alert apparatus 200 incorporating teachings of the present disclosure. As shown in FIG. 2, the early alert apparatus 200 for a process instrument comprises: a measurement value receiving unit 202, a first estimation value determining unit 204, a second estimation value determining unit 206, an estimation value computing unit 208 and an overall prediction unit 210.

The measurement value receiving unit 202 is configured to receive a measurement value of a process variable measured by a process instrument.

The first estimation value determining unit 204 is configured to predict a linear estimation value using a linear prediction model, which is generated by performing linear fitting on a predetermined number of measurement values recently measured by the process instrument, compare the linear estimation value with a preset warning threshold, and if the linear estimation value is greater than the preset warning threshold, set the linear estimation value as a first estimation value.

The second estimation value determining unit 206 is configured to analyse a position of a current measurement value in a measurement value cycle of the process variable, compare the current measurement value with a value of the process variable at the same position in the previous cycle to determine a deviation value, then add the deviation value to the previous peak value or trough value to serve as a maximum estimation value, compare the maximum estimation value with the preset warning threshold, and if the maximum estimation value is greater than the preset warning threshold, set the maximum estimation value as a second estimation value.

The estimation value computing unit 208 is configured to compute a process variable estimation value on the basis of the first estimation value and the second estimation value.

The overall prediction unit 210 is configured to compare the process variable estimation value with the preset warning threshold, and issue an early alert signal if the process variable estimation value is greater than the preset warning threshold.

The estimation value computing unit 208 is further configured to: compute the process variable estimation value in a weighted manner on the basis of the first estimation value and the second estimation value and respective weights thereof.

The measurement value cycle is obtained by analysing received measurement values of multiple process variables to determine the periodicity of the process variables.

In some embodiments, the early alert apparatus 200 for a process instrument may further comprise a user setting unit 209, configured to receive a time period and a maximum threshold set by a user, wherein the overall prediction unit is further configured to estimate an accumulated value of the process variable within the time period on the basis of the first estimation value and/or the second estimation value, and issue an early alert signal if the accumulated value is greater than the maximum threshold.

In some embodiments, the early alert apparatus 200 may be used to perform corresponding steps of the early alert method described above with reference to FIG. 1; details of the operations and functions of the various parts of the early alert apparatus 200 may be identical or similar to the relevant parts of embodiments of the early alert method 100 described with reference to FIG. 1, so are not described in detail again here. It should be explained that the structure of the early alert apparatus 200 shown in FIG. 2 and its component units are merely exemplary, and those skilled in the art may modify the structural block diagram shown in FIG. 2 as needed.

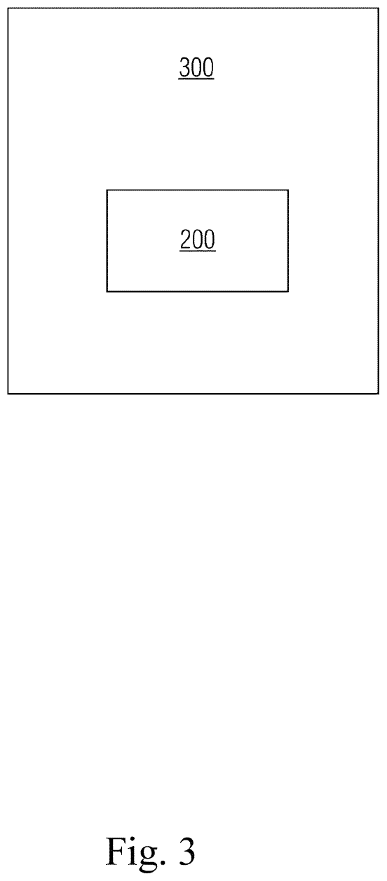

FIG. 3 shows a schematic drawing of a process instrument 300 incorporating teachings of the present disclosure. The process instrument 300 comprises an early alert apparatus 200 shown in FIG. 2, which can perform corresponding steps of the early alert method described above with reference to FIG. 1. The process instrument 300 shown in FIG. 3 can issue an early warning for a process variable that might exceed a warning threshold, thus enabling earlier fault prediction and diagnosis, and avoiding greater damage during production.

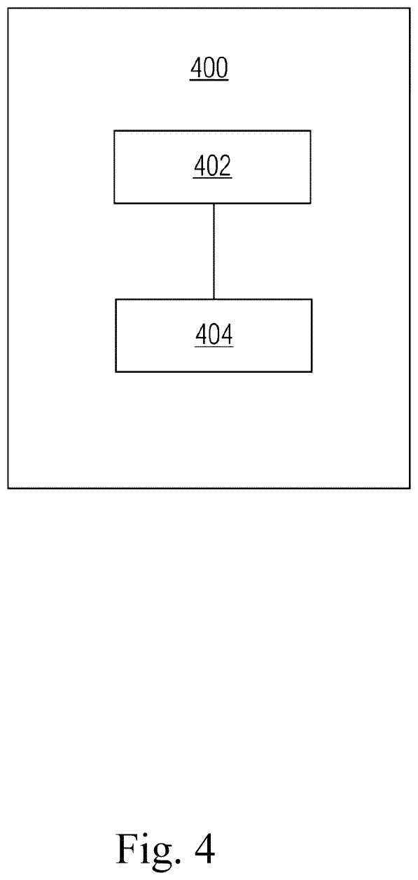

FIG. 4 shows a block diagram of an example computing device 400 for executing an early alert method incorporating teachings of the present disclosure. In some embodiments, the computing device 400 may comprise at least one processor 402, the processor 402 executing at least one computer-readable instruction (i.e. the abovementioned element realized in the form of software) stored or encoded in a computer-readable storage medium (i.e. a memory 404).

The computer-executable instruction stored in the memory 404, when executed, causes the at least one processor 402 to perform one or more of the various operations and functions described above with reference to FIGS. 1-3 in embodiments of the present disclosure.

In some embodiments, a non-transitory machine-readable medium stores a machine-executable instruction (i.e. the abovementioned element realized in the form of software) which, when executed by a machine, causes the machine to execute the various operations and functions described above with reference to FIGS. 1-3.

In some embodiments, a computer program includes a computer-executable instruction which, when executed, causes at least one processor to execute one or more of the various operations and functions described above with reference to FIGS. 1-3.

In some embodiments, a computer program product comprises a computer-executable instruction which, when executed, causes at least one processor to execute one or more of the various operations and functions described above with reference to FIGS. 1-3.

All of the embodiments herein are described progressively; for parts which are identical or similar in different embodiments, the corresponding embodiment may be referred to; and each embodiment focuses on describing differences from other embodiments.

Specific embodiments have been described above. Other embodiments are within the scope of the attached claims. In some situations, actions or steps recorded in the claims may be executed in a different order from that in the embodiments and still achieve the desired result. Furthermore, the processes depicted in the drawings do not necessarily require the displayed specific order or consecutive order in order to achieve the desired result. In some embodiments, multi-task processing and parallel processing are also possible or possibly advantageous.

Not all of the steps and units in the structural drawings of the processes and systems above are necessary; some steps or units may be omitted according to actual needs. The apparatus structures described in the embodiments above may be physical structures or logic structures, i.e. some units might be realized by the same physical entity, or some units might be realized by multiple physical entities separately or may be realized jointly by certain components in multiple independent devices.

The specific implementations expounded above with reference to the drawings describe exemplary embodiments, but do not represent all embodiments that can be realized or that fall within the scope of protection of the claims. The term “exemplary” used throughout this Description means “serving as an example, instance or illustration”, and does not mean “preferred” or “advantageous” compared to other embodiments. In order to provide an understanding of the technologies described, specific embodiments include specific details. However, these technologies may be implemented in the absence of these specific details. In some instances, to avoid making the concepts of the described embodiments difficult to understand, well known structures and apparatuses are shown in the form of block diagrams.

The above description of the content of the present disclosure is provided to enable any person skilled in the art to realize or use the content of the present disclosure. To a person skilled in the art, various modifications to the content of the present disclosure will be obvious, and the general principles defined herein may be applied to other variants without departing from the scope of protection of the content of the present disclosure. Thus, the content of the present disclosure is not limited to the examples and designs described herein but is consistent with the broadest scope conforming to the principles and novel features disclosed herein.

The above are merely example embodiments of the teachings of the present disclosure and do not limit the scope of the disclosure. Any modifications, equivalent substitutions or improvements, etc. made within the spirit and principles of the present disclosure are included in the scope of protection thereof.

What is claimed is:

1. An early alert method for a process instrument, the method comprising:
receiving a measurement value of a process variable measured by a process instrument;
predicting a linear estimation value using a linear prediction model generated by performing linear fitting on a predetermined number of measurement values recently measured by the process instrument, comparing the linear estimation value with a preset warning threshold, and if the linear estimation value is greater than the preset warning threshold, setting the linear estimation value as a first estimation value;
analysing a position of a current measurement value in a measurement value cycle of the process variable, comparing the current measurement value with a value of the process variable at the same position in the previous cycle to determine a deviation value, then adding the deviation value to the previous peak value or trough value to serve as a maximum estimation value, comparing the maximum estimation value with the preset warning threshold, and if the maximum estimation value is greater than the preset warning threshold, setting the maximum estimation value as a second estimation value;
computing a process variable estimation value on the basis of the first estimation value and the second estimation value; and
comparing the process variable estimation value with the preset warning threshold, and issuing an early alert signal if the process variable estimation value is greater than the preset warning threshold.

2. The method as claimed in claim 1, further comprising
computing the process variable estimation value in a weighted manner on the basis of the first estimation value and the second estimation value and respective weights thereof.

3. The method as claimed in claim 1, further comprising obtaining the measurement value cycle by analysing received measurement values of multiple process variables to determine the periodicity of the process variables.

4. The method as claimed in claim 1, further comprising, before the overall prediction, receiving a time period and a maximum threshold set by a user;
wherein the overall prediction step further comprises estimating an accumulated value of the process variable within the time period on the basis of the first estimation value and/or the second estimation value; and
issuing an early alert signal if the accumulated value is greater than the maximum threshold.

5. An early alert apparatus for a process instrument, the apparatus comprising:
a measurement value receiving unit to receive a measurement value of a process variable measured by a process instrument;
a first estimation value determining unit to predict a linear estimation value using a linear prediction model, which is generated by performing linear fitting on a predetermined number of measurement values recently measured by the process instrument, compare the linear estimation value with a preset warning threshold, and if the linear estimation value is greater than the preset warning threshold, set the linear estimation value as a first estimation value;
a second estimation value determining unit to analyse a position of a current measurement value in a measurement value cycle of the process variable, compare the current measurement value with a value of the process variable at the same position in the previous cycle to determine a deviation value, then add the deviation value to the previous peak value or trough value to serve as a maximum estimation value, compare the maximum estimation value with the preset warning threshold, and if the maximum estimation value is greater than the preset warning threshold, set the maximum estimation value as a second estimation value;
an estimation value computing unit to compute a process variable estimation value on the basis of the first estimation value and the second estimation value; and
an overall prediction unit to compare the process variable estimation value with the preset warning threshold, and issue an early alert signal if the process variable estimation value is greater than the preset warning threshold.

6. The apparatus as claimed in claim 5, the estimation value computing unit further configured to:
compute the process variable estimation value in a weighted manner on the basis of the first estimation value and the second estimation value and respective weights thereof.

7. The apparatus as claimed in claim 5, wherein the measurement value cycle is obtained by analysing received measurement values of multiple process variables to determine the periodicity of the process variables.

8. The apparatus as claimed in claim 5, further comprising a user setting unit to receive a time period and a maximum threshold set by a user;
wherein the overall prediction unit is further configured to estimate an accumulated value of the process variable within the time period on the basis of the first estimation value and/or the second estimation value, and issue an early alert signal if the accumulated value is greater than the maximum threshold.

9. (canceled)

10. A computing device comprising:
at least one processor; and
a memory coupled to the at least one processor, the memory storing an instruction which, when executed by the at least one processor, causes the at least one processor to:
receive a measurement value of a process variable measured by a process instrument;
predict a linear estimation value using a linear prediction model generated by performing linear fitting on a predetermined number of measurement values recently measured by the process instrument, comparing the linear estimation value with a preset warning threshold, and if the linear estimation value is greater than the preset warning threshold, setting the linear estimation value as a first estimation value;
analyse a position of a current measurement value in a measurement value cycle of the process variable, comparing the current measurement value with a value of the process variable at the same position in the previous cycle to determine a deviation value, then adding the deviation value to the previous peak value or trough value to serve as a maximum estimation value, comparing the maximum estimation value with the preset warning threshold, and if the maximum estimation value is greater than the preset warning threshold, setting the maximum estimation value as second estimation value;
compute a process variable estimation value on the basis of the first estimation value and the second estimation value; and compare the process variable estimation value with the preset warning threshold, and issuing an early alert signal if the process variable estimation value is greater than the preset warning threshold.

11.-12. (canceled)
